(19) United States
(12) Patent Application Publication
(10) Pub. No.: US 2024/0408762 A1
(43) Pub. Date: Dec. 12, 2024

(54) Industrial Robot with A Peer-To-Peer Communication Interface to Support Collaboration Among Robots

(71) Applicant: ABB Schweiz AG, Baden (CH)

(72) Inventors: Krister Landernäs, Hallstahammar (SE); Zhibo Pang, Västerås (SE); Ognjen Dobrijevic, Västerås (SE); Pawel Wiatr, Upplands Väsby (SE)

(21) Appl. No.: 18/551,247

(22) PCT Filed: Mar. 26, 2021
(86) PCT No.: PCT/EP2021/058028

§ 371 Date: Sep. 19, 2023

(51) Int. Cl. B25J 9/16; B25J 13/00; G05B 19/4155

(52) U.S. Cl. CPC B25J 9/1682; B25J 13/006; G05B 19/4155; G05B 2219/50391

(57) ABSTRACT

An industrial robot adapted for operation in a factory environment includes: sensors, actuators, a robot controller and a wireless interface configured to establish a sidelink to a further industrial robot or a group of industrial robots after a successful proximity verification. The industrial robot is configured to participate in execution of a utility task, which is carried out in collaboration with the further industrial robot or at least some members of the group of industrial robots, said collaboration including an exchange of operational data over the sidelink. An example utility task is the coordinated transfer of an object by multiple participating industrial robots. Another example is the collecting of map information by multiple participating industrial robots.

### TECHNICAL FIELD

The present disclosure relates to the field of robotic control and in particular to communication techniques for supporting inter-robot collaboration.

### BACKGROUND

It is envisioned that cellular factory networks will be used to enable communication among industrial robots, including stationary robots (SR) as well as mobile robots (MR). In the cellular network, a transmission from a sending robot will normally be routed to the recipient robot through network infrastructure of the factory network, e.g., wireless access point, base station. The transmission will travel in an uplink from the sending robot and onwards in a downlink to the recipient robot. The performance of these radio links in terms of latency and jitter will depend on the prevailing network load, the spatial extent of the radio links (practically speaking, each robot's distance to its nearest access point), resource allocation decided by schedulers in the network, etc. In industrial sites with difficult radio conditions, it might not be possible to reliably guarantee a maximum communication latency, nor to obtain a satisfactory jitter level.

It would be desirable to improve today's inter-robot communication techniques so as to enable sophisticated robot collaboration tasks.

### SUMMARY

One objective of the present disclosure is to make improved communication techniques available for the support of inter-robot collaboration. It is a particular objective to provide communication techniques adapted for a factory environment. Another objective is to propose an industrial robot with communication modalities allowing it to participate in demanding collaborative tasks.

These and other objectives are achieved by the invention as defined in the independent claims. The dependent claims relate to advantageous embodiments.

In a first aspect of the invention, there is provided an industrial robot adapted for operation in a factory environment. The industrial robot comprises sensors, actuators, a robot controller and a wireless interface configured to establish a sidelink to a further industrial robot or a group of industrial robots after a successful proximity verification. According to the first aspect, the industrial robot is configured to participate in execution of a utility task, which is carried out in collaboration with the further industrial robot or at least some members of the group of industrial robots, said collaboration including an exchange of operational data over the sidelink.

Sidelink, when configured with ordinary values of transmit power and other physical-layer settings, may have a radio range of 10 m or more, which is adequate in view of the typically much smaller separation of industrial robots that participate in a common utility task. The operational data is exchanged over the sidelink without passing via an access point or base station or any other infrastructure belonging to the cellular network. This limits the impact of jitter and latency. Further, the performance of the sidelink is largely decoupled from the load prevailing in the cellular network which supports and manages the setting-up of the sidelink. All this renders the industrial robot according to the first aspect suitable for inter-robot collaboration use cases where fast and reliable (mission-critical) communication is important.

The endpoints of the operational data exchange may be the robot controllers of the respective industrial robots. The operational data may represent real-time state variables and control signals pertaining to the sensors and actuators; such data is amenable to supporting the individual operation of the communicating industrial robots and to supporting their collaborative execution of the utility task. The sidelink may furthermore be utilized for exchange of non-real-time quantities, such as maintenance records, configuration data and other documentation. The industrial robot and the further industrial robot(s) are interoperable in the sense that they may be structurally similar (e.g., each may comprise a minimum set of sensors, actuators, a robot controller and a wireless interface configured for sidelink communication) or they may be equivalent from a functional point of view.

In one embodiment, the utility task is or includes a coordinated transfer of an object by multiple participating industrial robots. The transfer may include lifting, carrying, moving, transporting and/or rotating.

In another embodiment, the utility task is or includes the collecting of map information by multiple participating industrial robots. The map information, which relates to an environment in which the participating industrial robots operate, may be captured by sensors in the industrial robots. It may include items of point-cloud data or image data, where each item is optionally annotated with pose or position data relating to the industrial robot at the time of capture.

In a further embodiment, there is provided a plurality of industrial robots (or robot fleet) which participate in the execution of a utility task which is said coordinated transfer of an object or said map information collection.

In a second aspect of the invention, there is provided a method of operating an industrial robot. The method comprises: verifying the industrial robot's proximity to a further industrial robot or a group of industrial robots; when the proximity verification is successful, establishing a sidelink to the further industrial robot or the group of industrial robots; and participating in execution of a utility task in collaboration with the further industrial robot or at least some members of the group of industrial robots. In connection with the collaboration, operational data is exchanged over the sidelink.

The invention further relates to a computer program containing instructions for causing a computer, or the robot controller in particular, to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

In this disclosure, the term “sidelink” shall have a meaning consistent with applicable sections of 3GPP Technical Specifications and Technical Reports. In such specifications and reports, “sidelink” may refer to a connection between two user equipments (UEs) which are assisted by a 3GPP LTE or NR radio access network to establish the sidelink. The term “sidelink” covers, furthermore, a device-to-device (D2D) connection, a Proximity Services (ProSe) connection, a PC5 interface and future technologies with equivalent characteristics and abilities. The term does not extend to IEEE 802.11 technologies.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, on which:

FIG. 1 shows two P2P-enabled mobile robots in a factory environment equipped with network infrastructure;

FIG. 2 illustrates an industrial robot which is about to establish a sidelink to a group of industrial robots and performs a proximity verification;

FIG. 3 shows stationary and mobile industrial robots participating in a coordinated transfer of an object;

FIG. 4 is a top view of a factory environment, in which multiple industrial robots participate in the collecting of map information to be processed by an edge server; and

FIG. 5 is a flowchart of a method of operating an industrial robot.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

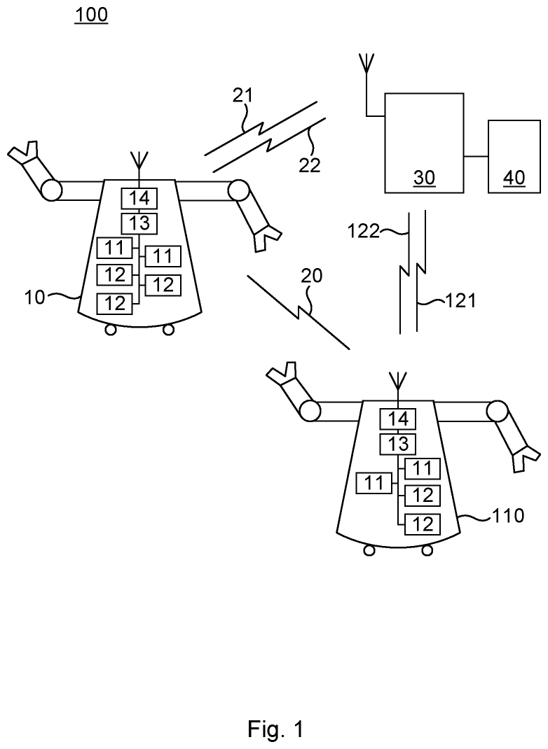

FIG. 1 shows two mobile robots 10, 110 in a factory environment 100 in which network infrastructure 30 and a fleet management system (FMS) 40 have been installed. Each robot 10, 110 comprises at least one sensor 11, actuator 12, robot controller 13 and a wireless interface 14 enabled for P2P communication. The at least one sensor 11 may for example be a rotary or linear encoder for a robot joint, a strain sensor, a pressure sensor, a thermometer or an optical sensor. The at least one actuator 12 may be a rotary or linear electric motor acting on a robot joint, a pneumatic or hydraulic piston, a valve, an end effector or an electric switch. The robot controller 13 may comprise application-specific or programmable processing circuitry and a memory storing a system configuration as well as basic or task-specific software.

The wireless interface 14 may be configured to maintain an uplink 121 and a downlink 122 to the network infrastructure 30, which may be a base station of a cellular radio access network (e.g., factory network) or an access point. The wireless interface 14 is further configured to establish a sidelink 20 to a corresponding interface, such as the wireless interface 14 of another robot. Each wireless interface 14 may comprise a transmitter side and a receiver side, or it may constitute a combined device. Each wireless interface 14 comprises or is connected to at least one antenna, which may be mounted on the surface of the robot 10, 110. The antenna may comprise multiple antenna elements, especially on the receiver side. In particular, the antenna may comprise an active antenna array with beamforming capabilities, which may be utilized to increase the reliability and/or energy efficiency of the sidelink 20. The beamforming can be controlled in a closed-loop fashion on the basis of radio measurements.

As discussed initially, sidelink may refer to a connection between two user equipments (UEs), here corresponding to the wireless interfaces 14, which are assisted by a 3GPP LTE (“4G”) or NR (“5G”) radio access network to establish the sidelink. For LTE, 3GPP Technical Specification 36.300 V12.10.0 and citations therein describe specifics such as reference signals, message formats, synchronization, discovery and setup procedures for establishing a sidelink connection autonomously (clause 23.10.1) and with network support (clause 23.11). For NR, 3GPP Technical Specification 38.300 V15.11.0 clause 16.9 with citations is relevant. Additional reference is made to the later versions and higher releases of these technical specifications.

While some implementations require the UEs to stay in communication with a Proximity Services (ProSe) function of the network to maintain a sidelink, the sidelink connections normally remain operable even outside coverage of the network infrastructure 30. After the sidelink 20 has been established between the robots 10, 110 in FIG. 1, the data exchanged on the sidelink 20 normally does not pass via any part of the network infrastructure, whether of the radio access network node or a core network or backhaul network. The data transmissions may be of unicast or broadcast type. Unicast transmission may be addressed to temporary network identifiers assigned to the wireless interfaces 14 by the radio access network 30, or at the setting up of the sidelink 20, such as SL-RNTI, SL N RNTI, SL-V-RNTI and further RNTIs. Alternatively, the addressing may refer to a semi-permanent or permanent subscriber identity or to a hardware identifier. In broadcast transmission, a Group ID (SL-G-RNTI) common to multiple UEs may be used.

The sidelink communication may be performed in licensed radio spectrum and may additionally utilize unlicensed spectrum. The carrier frequency may be of the order of GHz or hundreds of MHz, and the bandwidth may be of the order of tens or hundreds of MHz. Sidelink communication, at least in licensed bands, rely on time-frequency communication resources which are allocated on demand by a scheduler function. According to some aspects, a baseline (or default, or minimum) resource allocation is requested when the sidelink 20 has been set up but not been put to use for any particular utility task. This baseline resource allocation is configured to support a rudimentary set of functions, such as positioning, diagnostics and emergency communication among the robots 10, 110. When the sidelink 20 is going to support the execution of an assigned utility task, a request for additional resources (extended resource allocation request) may be submitted to the network 30, wherein the requisite bandwidth, throughput and/or quality-of-service (QoS) may be specified. The extended resource allocation is more comprehensive than a baseline resource allocation.

The sidelink 20 may be used for an exchange of operational data between the respective robot controllers 13 when the robots 10, 110 are stationary or moving. The operational data may constitute real-time state variables (observables) pertaining to the sensors 11 and control signals (commands) pertaining to actuators 12, such as propulsion means, joints, end effector or other technical systems. It is understood that the actuators 12 are configured to respond to control signals generated by the robot controller 13 as well as control signals received via the wireless interface 14.

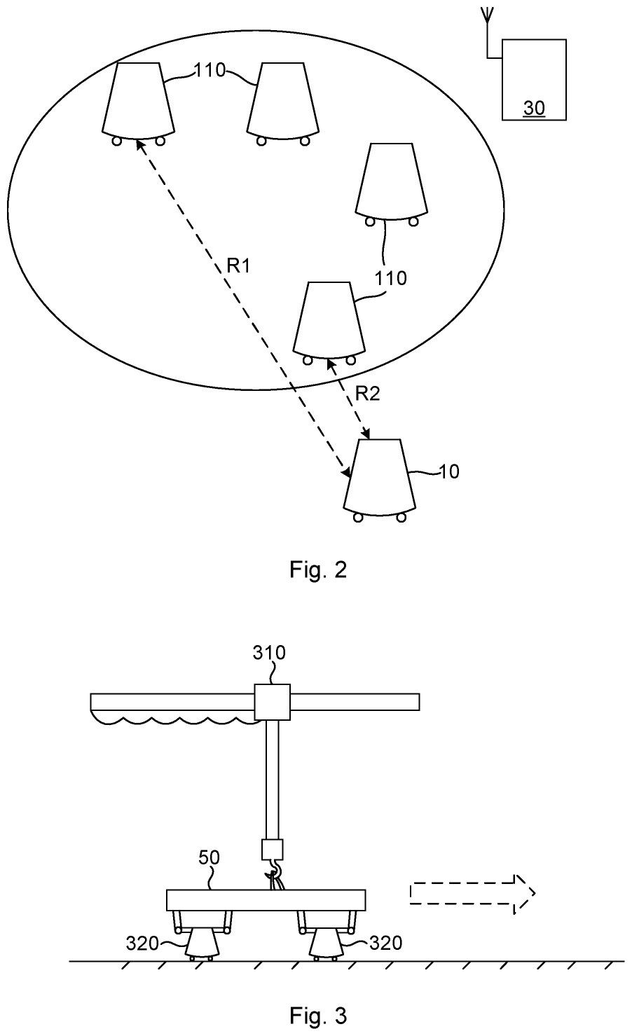

Since sidelink is specified for shorter ranges than a typical cell diameter, one industrial robot 10 may be in coverage by the network infrastructure 30 yet too far from the other industrial robot 110 for sidelink communication to be possible. The wireless interface 14 of the robot 10 is therefore configured to establish the sidelink 20 only after a proximity verification has been successfully completed. If the wireless interface 14 is about to connect to a group of robots 10, the proximity verification may apply an any-of criterion or an all-of criterion. More precisely, as illustrated in FIG. 2 where the encircled industrial robots 110 form a sidelink group, the establishment of the sidelink 20 may be enabled as soon as the closest robot 110 in the group is within the specified range R0 (i.e., R25R0) even though another robot 110 in the group is outside (R2>R0). Alternatively, under the all-of criterion, the establishment of the sidelink 20 is enabled only if the most distant robot 110 in the group is within the specified range (R1<R0).

The FMS 40 supervises the industrial robots 10, 110 and may for this purpose include monitoring and/or control functionalities. The FMS 40 may be configured to perform mobile robot route planning and to manage the execution of these routes by the industrial robots 10, 110. The FMS 40 may also be authorized to assign utility tasks to the industrial robots 10, 110, either individually or groupwise. Further, the FMS 40 periodically collects the current positions of all the industrial robots 10, 110 and it may predict future positions on the basis of the planned routes. The wireless interface's 14 proximity verification discussed above may be based on position data obtained from the FMS 40.

The industrial robot 10 is configured to participate in the execution of a utility task, which is carried out in collaboration with the further industrial robot 110 or at least some members of a group of industrial robots, to which the industrial robot 10 is connected via the sidelink 20. The collaboration includes an exchange of operational data over the sidelink 20. For example, the execution of the utility task may be interactively controlled on the basis of the operational data exchanged over the sidelink 20. To enable such collaboration, each industrial robot 10 is configured to make available, as said operational data to be exchanged, real-time state variables read from the sensors 11 and control signals addressing the actuators 12. The control signals may be generated by the robot controller 13. At least a subset of the control signals and/or state variables prevailing in the robot 10 are made available in this fashion.

FIG. 3 shows stationary 310 and mobile 320 industrial robots participating in an example coordinated transfer of an object 50, which is an example utility task. The transfer may include lifting, carrying, moving, transporting and/or rotating the object 50. In limited spaces, including warehouses and factories, it is often advantageous to assign a transfer task to multiple industrial robots that each is easily maneuverable but would be unable to transfer the object 50 on its own due to limitations in gripper dimensions, gripper capacity, lifting capacity, vertical reach, propulsion power etc. In the example in FIG. 3, the object 50 is initially lifted by the stationary robot 310, which includes an overhead crane, then supported by the two mobile robots 320 which move the object 50 horizontally towards the destination, in the direction of the hollow dashed arrow. The transfer task has several non-deterministic features that may differ across execution cycles, including the angular position of the object 50 when suspended from the overhead crane's hook, oscillations, temporary obstacles blocking the path towards the destination etc. To compensate such factors, reliable inter-robot communication with low delay is very useful. The execution of the transfer task may further include closed-loop control of actuators.

In one embodiment, the transfer task is planned and/or supervised by a primary robot, which is one of the participating stationary 310 and mobile 320 robots. The primary robot may be appointed by the FMS 40 in connection with the assignment of the transfer task. Alternatively, the robots to which the transfer task is assigned may negotiate and appoint the primary robot between themselves using a deterministic (rule-based) or stochastic algorithm. Example rules for appointing the primary robot may include:
the primary robot shall be a mobile robot (which follows the object 50 throughout the execution of the transfer task);
the primary robot shall be the one positioned closest to the destination at the time of appointment (which can travel at the front without a need to re-sequence the robots); and/or
the primary robot shall be the one with the largest remaining battery energy (which can continue to participate in the task even if another robot needs to be replaced).

The primary robot may be configured to receive state variables from the participating industrial robots and to determine, on the basis of these, control signals to be applied in the participating industrial robots. In the example of FIG. 3, this may include receiving a camera signal from the stationary robot 310 that indicates the vertical position and horizontal orientation of the object 50 and to determine, on that basis, a suitable point in time for depositing the object 50 onto the mobile robots 320. During the depositing of the object 50, a lift motor (actuator) in the stationary robot 310 may be controlled in a closed-loop fashion on the basis of a distance sensor in one of the mobile robots 320 that monitors in real time the position of the lower edge of the object 50 relative to the mobile robots 320, to enable smooth deposition. A further responsibility of the primary robot may be to perform path planning for the horizontal phase of the transfer. The path planning may include determining independent paths for the participating multiple mobile robots 320; this improves the ability to move the object 50 past corners, into and out of constrained spaces. The primary robot may further plan a sequence of robot movements and/or object movements for carrying out the coordinated transfer of the object 50; the control signals to be applied in the participating industrial robots are then determined on the further basis of the planned sequence of movements. A still further responsibility of the primary robot may be to request an increased sidelink resource allocation for the participating industrial robots during the coordinated transfer of the object 50. The increase may be expressed in terms of a QoS parameter, such as maximum delay. Reference is made to the above discussion regarding resource allocation. The transfer operation may further include one or more checkpoints requiring a verification that the observables of the system (e.g., locations, orientations, inter-unit distances, equipment temperature, battery energy) are within specified ranges.

At least some of the robots participating in the coordinated transfer of the object 50 may be configured to act as a non-primary robot when it is not appointed to be the primary robot. This may include making state variables available to the primary robot and to apply (execute) the control signals that the non-primary robot receives from the primary robot. Notwithstanding this ability, the non-primary robot may continue to execute any control signals that its own robot controller 13 generates.

In another embodiment, the industrial robots participating in a coordinated transfer of an object 50 may all be mobile industrial robots 320. In another embodiment, the coordinated transfer of an object 50 may be supported by operator interaction.

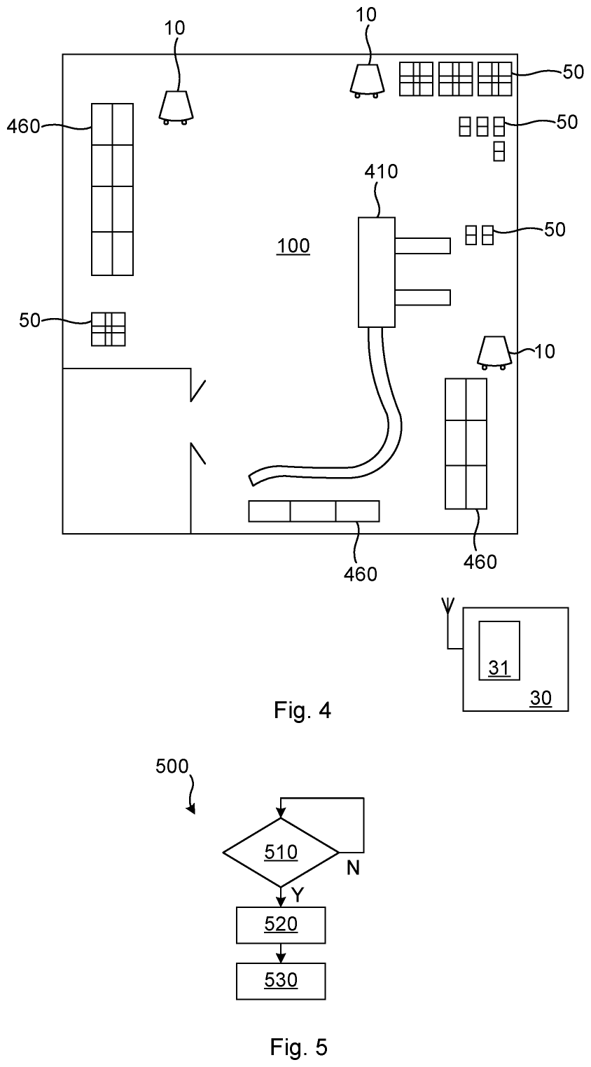

FIG. 4 is a top view of a factory environment 100, in which multiple industrial robots 10 participate in the collecting of map information to be processed by an edge server. The collecting of map information is an example utility task. Delimited by outer and inner building walls drawn in solid line, the example factory environment 100 is designed for the handling and dispatch of goods 50, which may comprise items of break-bulk cargo. For these purposes, suspended, floor- and wall-mounted furniture 460 is installed in the environment 100 as well as a stationary robot 410 with inward and outward conveyors configured to sort and wrap the goods 50. At least parts of the furniture 460 can be repositioned to adapt the environment 100 between different batches. Human operators, forklifts as well as autonomous mobile robots 10 circulate in the environment 100, which makes the navigable space in the environment 100 highly variable. Moreover, the positions of workpieces 50 in processing may change rapidly, doors may be temporarily closed etc. For safety purposes and to facilitate efficient planning of motion paths, loading and unloading, an edge server 31 is configured to maintain an up-to-date map of the environment 100. The edge server 31 may be integrated in or associated with network infra-structure 30 which provides the robots 10, 410 with wireless connectivity, e.g., in the form of a cellular factory network. It maintains the map of the environment 100 on the basis of map information that the mobile industrial robots 10 collect and report to the edge server 31.

To allow collection of the map information, at least some of the mobile robots 10 are equipped with suitable sensors. The sensors may include exteroceptive sensors (e.g., color-depth sensor, lidar, acoustic, radar, optical) and proprioceptive sensors (e.g., configured for an angular measurement, a delta-parallax measurement, an odometric or dead-reckoning measurement) or combinations thereof (e.g., SLAM sensor). In one embodiment, the industrial robot 10 is configured to report map information including sensor data from these sensors. The sensor data may be raw or preprocessed. It may relate to point-cloud data, image data, pose data and/or position data. In another embodiment, the industrial robot 10 is configured to generate a local map on the basis of data collected by the sensors. The local map may be generated by a SLAM algorithm, and it may relate to those areas of the environment 100 that the robot 10 has visited. As a data set, the local map may have a higher density of useful information than the sensor data.

The industrial robot 10 may be configured to report the map information to edge server 31 via the uplink towards the network infrastructure 30. Alternatively, the industrial robot 10 is configured to report the map information via a sidelink 20 to the stationary robot 410, which forwards it to the edge server 31. The use of the sidelink 20 reduces the load on the factory network and may be lower delay. The stationary robot 410, in turn, has a fixed position relative to the network infrastructure 30 and may thereby benefit from more favorable and/or more stable radio conditions. Further alternatively, those industrial robots 10, which participate in the task of collecting map information of a common environment 100, may share and combine the sensor data among themselves before forwarding it to the edge server 31. For example, the sensor data from the different industrial robots 10 may be processed (combined) into a common local map of a region of the environment 100, and the local map rather than the sensor data is transmitted to the edge server 31. The processing for providing the local map may be entrusted to a primary robot, which may be appointed by an FMS 40 or appointed among the participating robots 10, in the manner described above for the object transfer task.

The edge server 31 may be a general-purpose computer programmed to generate a map of the environment 100. It may from a functional point of view constitute a centralized entity, but this does not exclude distributed implementations that rely, at least in part, on networked (cloud) resources. The edge server 31 is configured to receive map information from at least two mobile robots 10 moving in the environment 100. The edge server 31 may include a non-volatile memory to offload a runtime memory for the purpose of storing finished or semi-finished cartographic data. The non-volatile memory may furthermore store a basic description of the environment 100, e.g., its outer limits according to the floor plan, while mobile objects such as furniture 460 and goods 50 are purposefully left out. The edge server 31 may make the resulting map available to a robot controller 13 or FMS 40 that plans and executes movement of the mobile robots 10 in the environment 100.

The edge server 31 may include processing circuitry configured to generate a map by executing a SLAM algorithm using as inputs the received map information. The SLAM algorithm may be a collaborative algorithm capable of multisensory integration, by which data from the at least two mobile robots 10 is combined in a common map generation process. To allow data from the various robots 10 to be combined, the processing circuitry is configured to pre-process the data into a compatible or interoperable common datatype, regardless of the different platforms on which the data was collected. The data is fed to the SLAM algorithm in this compatible format. The pre-processing may include collapsing three-dimensional point data collected by the robots 10 into a two-dimensional plane corresponding to the factory floor of the environment 10.

For a further discussion of the collaborative collecting of map information by multiple industrial robots 10, reference is made to the applicant's earlier disclosure PCT/EP2021/052937.

FIG. 5 is a flowchart of a method 500 of operating an industrial robot 10.

In an initial step 510, the industrial robot's proximity to a further industrial robot 110 or a group of industrial robots is verified. If the proximity verification cannot be completed or returns a negative outcome (N branch), the execution of the method 500 loops back to the initial step 510, which may be repeated after a predefined delay or after confirmation by an operator.

If instead the proximity verification is successful (Y branch) then, in a step 520, a sidelink 20 to the further industrial robot 110 or the group of industrial robots is established.

With the sidelink 20 established, the industrial robot 10 may then, in a third step 530, participate in the execution of a utility task in collaboration with the further industrial robot 10 or at least some members of the group of industrial robots. The collaboration includes an exchange of operational data over the sidelink 20.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. An industrial robot adapted for operation in a factory environment, the industrial robot comprising:
sensors;
actuators;
a robot controller; and
a wireless interface configured to establish a sidelink to a further industrial robot or a group of industrial robots after a successful proximity verification,
wherein the industrial robot is configured to participate in execution of a utility task, which is carried out in collaboration with the further industrial robot or at least some members of the group of industrial robots, said collaboration including an exchange of operational data over the sidelink.

2. The industrial robot of claim 1, wherein the execution of the utility task is interactively controlled on the basis of the operational data exchanged over the sidelink.

3. The industrial robot, of claim 1, which is configured to make available real-time state variables and control signals pertaining to said sensors and actuators as said operational data to be exchanged over the sidelink.

4. The industrial robot of claim 1, wherein the industrial robot and the further industrial robot or group of industrial robots are supervised by a fleet management system, FMS, and the proximity verification is based on position data obtained from the FMS.

5. The industrial robot of claim 1, wherein the industrial robot and the further industrial robot or group of industrial robots are supervised by a FMS, and the utility task is assigned by the FMS.

6. The industrial robot of claim 1, wherein the utility task includes coordinated transfer of an object by multiple participating industrial robots.

7. The industrial robot of claim 6, wherein the coordinated transfer is planned and/or supervised by a primary robot appointed among the participating industrial robots.

8. The industrial robot of claim 7, which is configured to act as said primary robot, which includes receiving state variables from the participating industrial robots and determining, on the basis of these, control signals to be applied in the participating industrial robots.

9. The industrial robot of claim 8, said primary robot's action further including planning a sequence of movements for carrying out the coordinated transfer of the object, wherein the control signals are determined on the further basis of the planned sequence of movements.

10. The industrial robot of claim 8, said primary robot's action further including requesting an increased sidelink resource allocation for the participating industrial robots during the coordinated transfer of the object.

11. The industrial robot of claim 7, which is configured to act as a non-primary robot in the coordinated transfer of the object, which includes making state variables available to the primary robot and to apply control signals received from the primary robot.

12. The industrial robot of claim 7, wherein the participating industrial robots includes at least one stationary robot and at least one mobile robot.

13. The industrial robot of claim 1, wherein:
the utility task includes collecting map information by multiple participating industrial robots; and
the map information pertains to an environment of the participating industrial robots and includes point-cloud data, image data, pose data and/or position data.

14. The industrial robot of claim 13, further configured to participate in said collection of map information and to transmit the collected map information towards an edge server.

15. The industrial robot of claim 14, which is a mobile robot configured to transmit the collected map information towards the edge server by the intermediary of a stationary robot.

16. The industrial robot of claim 13, further comprising at least one exteroceptive sensor and at least one proprioceptive sensor.

17. A method of operating an industrial robot, the method comprising:
verifying the industrial robot's proximity to a further industrial robot or a group of industrial robots;
in response to the proximity verification being successful, establishing a sidelink to the further industrial robot or the group of industrial robots; and
participating, in execution of a utility task in collaboration with the further industrial robot or at least some members of the group of industrial robots, said collaboration including an exchange of operational data over the sidelink.

18. A computer program comprising instructions to cause an industrial robot to execute a method of operating an industrial robot, the method comprising:
verifying the industrial robot's proximity to a further industrial robot or a group of industrial robots;
in response to the proximity verification being successful, establishing a sidelink to the further industrial robot or the group of industrial robots; and
participating in executing of utility task in collaboration with the further industrial robot or at least some members of the group of industrial robots, said collaboration including an exchange of operational data over the sidelink.
